(19) United States
(12) Patent Application Publication
(10) Pub. No.: US 2014/0270042 A1
(43) Pub. Date: Sep. 18, 2014

(54) SOURCE OF ELECTRICITY DERIVED FROM A SPENT FUEL CASK

(71) Applicant: Westinghouse Electric Company LLC, (US)

(72) Inventor: Jeffrey T. Dederer, Valencia, PA (US)

(73) Assignee: Westinghouse Electric Company LLC, Cranberry Township, PA (US)

(21) Appl. No.: 13/798,271

(22) Filed: Mar. 13, 2013

(51) Int. Cl. G21C 19/07; G21D 1/02; G21D 5/04

(52) U.S. Cl. CPC G21C 19/07; G21D 5/04; G21D 1/02
USPC 376/272

(57) ABSTRACT

Apparatus for extracting useful electric or mechanical power in significant quantities from the decay heat that is produced within spent nuclear fuel casks. The power is used for either powering an active forced air heat removal system for the nuclear casks, thereby increasing the thermal capacity of the casks, or for emergency nuclear plant power in the event of a station blackout. Thermoelectric generators or other heat engines are employed using the thermal gradient that exists between the spent nuclear fuel and the environment surrounding the cask's components housing the nuclear fuel to produce the power.

### BACKGROUND

1. Field

This invention pertains generally to power sources that derive their energy from decay heat and, more particularly, from such a power source that derives its energy from a nuclear spent fuel storage cask containing spent nuclear fuel.

2. Related Art

Pressurized water nuclear reactors are typically refueled on an 18-month cycle. During the refueling process, a portion of the irradiated fuel assemblies within the core are removed and replaced with fresh fuel assemblies which are relocated around the core. The removed spent fuel assemblies are typically transferred under water to a separate building that houses a spent fuel pool in which these radioactive fuel assemblies are stored. The water in the spent fuel pools is deep enough to shield the radiation to an acceptable level and prevents the fuel rods within the fuel assemblies from reaching temperatures that could breach the cladding of the fuel rods, which hermetically house the radioactive fuel material and fission products. Cooling continues at least until the decay heat within the fuel assemblies is brought down to a level where the temperature of the assemblies is acceptable for dry storage. Typically, the spent fuel assemblies are stored in such pools for a period of fifteen years during which the assemblies can be cooled while they produce decay heat which decays exponentially with time. After fifteen years, the decay heat has decreased sufficiently that the assemblies can be removed from the spent fuel pool and transferred into long-term storage casks, each typically capable of holding 21 assemblies. These casks are generally relocated to another area on the nuclear plant site and stored indefinitely.

Since the fuel assemblies continue to produce decay heat in the casks, a natural convection air flow is used to provide for heat removal. This keeps the interior cask's temperatures at a level that is suitable for the materials used. Each cask has an interior stainless steel cylindrical canister that contains the spent fuel assemblies. This canister is placed in the storage casks' structural housing which is a thick reinforced cylindrical concrete shell that is lined on the inside face with stainless steel. There is an approximately 3.50 inch radial gap between the inner canister and the outer casks housing when assembled. This geometrical arrangement is shown in FIGS. 1 and 2. FIG. 1 shows the casks shell 10 cut away without the inner canister installed. The casks shell 10 typically comprises three annular concrete sections, a lower segment 12, a middle segment 14 and an upper segment 16, that are laterally restrained by shear keys 18 and are held in position by the tie rods 20. A steel liner 22 surrounds the interior of the segments 12, 14 and 16 and is capped by a thermal shield 24 and annular shield ring 26. Support rails 28 vertically extend along the interior of the segments 12, 14 and 16 and guide the stainless steel canister into position and space the canister from the interior walls of the steel liner 22. Support tubes 30 at the lower end of the central opening 42 in the outer segments 12, 14 and 16 support the inner stainless steel canister 36 shown in FIG. 2. An air inlet 32 typically capped by a screen 34 funnels air through the lower portion of the bottom segment 12 of the concrete shell 10 through the interior of the concrete shell into the annular passage between the shell 10 and the interior cylindrical canister that fits within the central opening in the concrete outer shell 10. The air entering through the intake 32 is exhausted through an air outlet passage 38 in the upper segment 16 of the concrete shell 10 that is capped by a screen 40. A top cover 41 is sealed by bolts 43 which extend through the cover and into the annular sealed ring 26 to secure the cover and the interior cylindrical canister 36 once filled with fuel assemblies and loaded within the central opening 42 of the concrete shell 10.

FIG. 2 shows the interior canister 36 that slides inside the outer concrete shell 10. The inner canister 36 has an outer steel shell 44 that is closed at the lower end by a bottom end plate 46 that covers a bottom shield plug 48 which is seated over a bottom closure plate 50. Spacer plates 52 are arranged within the inner canister shell 44 in a spaced tandem array and have substantially aligned square openings 56 into which the individual fuel assemblies are positioned. The aligned openings 56 maintain a designed spacing between fuel assemblies. The spacer plates 52 are held in position by an assembly of support rods 54 which extend therethrough around the perimeter of the spacer plates. A drain port 58 and vent port 60 span substantially the length of the canister shell 44 to evacuate water in the canister. The top of the canister 36 is closed by a top shield plug 62 which is covered by a top inner closure plate 64. The top inner closer plate 64 includes an instrument port 66 which communicates with radiation and temperature monitors within the canister to communicate corresponding output signals to the exterior of the canister 36. The inner canister assembly is covered by a top outer closure plate 68 fastened in place by circumferential bolts and includes a leak test port 70 for assuring a hermetical seal on the inner canister. The flow of cooling air enters the annulus at the bottom of the cask's shell 10 through the radial inlet passages 32 and the heating that incurs within the annulus between the inner canister 36 and the steel liner 22 of the outer concrete shell 10 induces a natural draft of air which is exhausted through the radial outlet passages 38 at the top of the cask. The residual decay heat from the spent fuel is thus dissipated over time to the surrounding environment.

It is an object of this invention to convert the waste heat from spent nuclear fuel within a spent nuclear fuel storage cask to useful work.

It is a further object of this invention to convert such waste heat to an energy source that can be used to further cool the spent fuel cask so that it can dissipate the heat from the spent fuel at an increased rate.

It is an additional object of this invention to convert such waste heat to mechanical or electrical energy which can be employed as an auxiliary power source for the facility in which the cask is stored.

### SUMMARY

These and other objects are achieved by a spent nuclear fuel storage container having a canister for storing nuclear fuel and a heat engine in heat transfer relationship with the canister for converting a differential in heat between the latent heat of the stored nuclear fuel and an ambient environment, into electrical or mechanical power. In one embodiment, the spent nuclear fuel storage container includes an outer cask surrounding the canister with an annular space therebetween. An air intake extends through a lower portion of the cask, extending from outside the cask to the annular space. An air outlet extends through an upper portion of the cask, extending from the annular space to the outside of the cask. Preferably, the heat engine is in heat transfer relationship with the annular space. In one embodiment, the heat transfer relationship is implemented through a heat transfer medium to transport heat from the annular space to an exterior of the outer cask. In one such embodiment, the heat transfer medium is a heat pipe and the heat engine may be selected from a Rankine cycle engine, a Sterling cycle engine or a thermoelectric device.

In still another embodiment, the heat engine is a thermoelectric device supported within the annular space on an outer surface of the inner canister that houses the nuclear fuel. Preferably, the thermoelectric device is supported at an elevation substantially between the air inlet and the air outlet. Desirably, the thermoelectric device is supported substantially midway between the air inlet and the air outlet.

In still another embodiment, the heat engine has an electrical output that is connected to a coolant circulation system operable to cool a coolant. Preferably, the circulation system extends through the annular space between the outer cask and the inner canister and through the cask to the exterior thereof, with the coolant circulation system circulating a fluid coolant between an interior of the annular space and the exterior of the cask.

In still another embodiment, the spent nuclear fuel storage container includes a coolant circulation system that cools the fluid within a spent fuel pool of a nuclear power plant. Desirably, the electric power forms an auxiliary power source for the nuclear plant.

### BRIEF DESCRIPTION OF THE DRAWINGS

A further understanding of the invention can be gained from the following description of the preferred embodiments when read in conjunction with the accompanying drawings in which:

FIG. 1 is an isometric view of the outer shell of a spent fuel casks partially exploded to show the top cover removed and partially in section exposing the interior thereof; FIG. 1 also schematically shows several embodiments of the application of waste heat from the spent nuclear fuel to power various facets of a nuclear facility;

FIG. 2 is an isometric view of an inner canister of a spent nuclear fuel cask partially exploded and cut away to expose the interior thereof that houses the spent nuclear fuel assemblies;

FIG. 3 is a schematic of a thermoelectric module that can be used as part of the power generation system employed in one embodiment of the spent nuclear fuel cask illustrated in FIGS. 1 and 2;

FIG. 4 is a graphical representation of the temperature profile of the outer concrete shell and inner canister surfaces of the spent fuel cask of FIGS. 1 and 2; and

FIG. 5 is an isometric view of a spent fuel cask showing the outer concrete shell with the inner canister partially removed.

### DESCRIPTION OF THE PREFERRED EMBODIMENT

This invention provides a means for converting waste heat from a spent fuel cask into electrical or mechanical power that can be used to support a multitude of functions. In one embodiment, thermoelectric generators are mounted on the outer surface of the inner canister of a spent fuel cask. The thermoelectric generators use the delta temperature difference between the inner canister housing the nuclear fuel and the air flow in an annular space between the inner canister and the outer concrete shell to produce power. Typically, commercially available thermoelectric devices will produce significant power when a delta T of 300° F. or better is placed across the devices. An exemplary thermoelectric device is illustrated in FIG. 3 and is generally designated by reference character 72. The thermoelectric device 72 generally consists of two or more elements of N and P-type doped semiconductor material 74 that are connected electrically in series and thermally in parallel. The N-type material is doped so that it will have an excess of electrons (more electrons than needed to complete a perfect molecular lattice structure) and P-type material is doped so that it will have a deficiency of electrons (fewer electrons than are necessary to complete a perfect lattice structure). The extra electrons in the N material and the “holes” resulting from the deficiency of electrons in the P material are the carriers which moves the heat energy from a heat source 76 through the thermoelectric material to a heat sink 78 which, in this case, is the annulus between the liner 22 on the inside of the concrete shell 10 and the inner canister shell 44. The electricity that is generated by a thermoelectric module such as that shown in FIG. 3 is proportional to the magnitude of the temperature difference between each side of the module. In accordance with this embodiment, the thermoelectric generator would be attached around the outer circumference of the inner cylindrical canister 36 in a band located approximately midway along the canister's axial height, which typically is between 75 and 125 inches (190.5 and 317.5 cm) from the bottom of the canister, i.e., approximately one fourth of the canister surface area. This surface area is noted in FIG. 2 by reference character 80 and one such thermoelectric generator is figuratively illustrated in FIG. 2 and designated by reference character 82. The temperature profile within the casks for different components is given in FIG. 4. As can be seen, the canister 36 surface temperature in the middle elevation area is approximately 470° F. The air temperature will necessarily be greater than the inside of the concrete housing and can be found from an energy balance on this component. Conservatively using the total convective and radiation heat transfer lost from the outer cask surface to the atmosphere, and equating this to the convective heat transfer to the inside of the concrete housing enables an estimate of air temperature within the annulus. Using a free convection heat transfer coefficient of 2.0 B/hr-ft²-degree Fahrenheit, the air temperature is found to be approximately ten degrees warmer than the housing surface or a maximum of 170° F. Thus, a 300° temperature difference exists between the canister shell 44 and the air stream in the central portion of the annulus between the shell 44 and the inner wall of the concrete outer shell 10.

Application of commercially available thermoelectric generator elements within this defined area will result in a power production of just over 10 kilowatts from each cask. Since the decay heat has already exponentially decayed for a minimum of fifteen years before the fuel assemblies are loaded in the casks, the remaining decay heat levels stay fairly constant, so this power is always available if needed. Once a spent fuel pool is full, each refueling offload requires three additional long-term storage casks, so a total of over 30 kilowatts of additional potential power is available every eighteen months, i.e., the refueling cycle. The thermoelectric generator elements 72 act like individual batteries and can be connected electrically in a combination of parallel and series arrangements to provide voltage and current levels for specific applications. This passively generated power can be used for many important things, for example, during a loss of on-site and off-site power (station blackout). Typically, during such conditions a plant must cope with only backup battery systems to power essential loads. For the AP1000, a passive nuclear plant design offered by Westinghouse Electric Company LLC, Cranberry Township, Pa., this coping capability is at least 72 hours, and for older existing plants, the period is much shorter. The power generated from each cask can be used to provide battery charging, control room lighting, instrumentation needs and power to cool a spent fuel pool such as that designated by reference character 84, schematically shown in FIG. 1, thereby extending the plant coping time under station blackout conditions.

The power produced in each cask 86, shown partially assembled in FIG. 5 with the fuel assembly bundles 88 within the inner canister 36, can be used to provide a forced draft of air in the annulus 90, thereby significantly increasing the heat removal capability of the casks 86. For this purpose, a thermoelectric generator element 82 is shown connected by an electrical lead 92 to an air blower or fan 94 that will move the air from the air intake 32 up through the annulus 90 and exhaust the air through the air outlet 38 in the upper portion of the concrete shell 10. Alternately, the blower or fan 94 can be positioned outside the concrete shell 10 and be connected by piping to the intake 32 and outlet 38 while being driven by a thermoelectric element within the annulus 90 powered through leads that extend through the concrete outer shell 10. Either arrangement for forcibly moving air through annulus 90 allows the fuel assemblies to be off loaded from the spent fuel pool at an earlier time and decreases the decay heat load on the spent fuel pool. This has the very positive result of reducing the cooling needs of the pool during station blackout conditions and improves the coping strategy for the plant.

Alternately, a heat pipe 96 can be employed extending through the annulus 90 and through the outer concrete shell 10 to convey the heat generated in the annulus 90 or within the canister 36 to the outside where it can be employed to drive a mechanical heat engine, such as a Sterling cycle or Rankine cycle engine as figuratively illustrated, respectively, by reference characters 98 and 100 in FIG. 1. Either of the Sterling cycle or the Rankine cycle engines can be employed to drive the blower 94 to force air through the annulus or drive a pump 102 which can be employed to circulate spent fuel pool water 106 through a heat exchanger 104 where it can be cooled and returned to the spent fuel pool 84. The operation of both the Rankine cycle engine and the Sterling cycle engine is more fully described in application Ser. No. 13/558,443, filed Jul. 26, 2012 (Attorney Docket No. CLS-UFS-001).

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. A spent nuclear fuel storage container comprising:
a canister for storing nuclear fuel; and
a heat engine in heat transfer relationship with the canister for converting a differential in heat between the latent heat of the stored nuclear fuel and an ambient environment into electrical or mechanical power.

2. The spent nuclear fuel storage container of claim 1 including:
an outer cask surrounding the canister with an annular space there-between;
an air intake through a lower end of the cask extending from outside the cask to the annular space;
an air outlet through an upper end of the cask extending from the annular space to the outside of the cask; and
wherein the heat engine is in heat transfer relationship with the annular space.

3. The spent nuclear fuel storage container of claim 2 wherein the heat transfer relationship is implemented through a heat transfer medium to transport heat from the annular space to an exterior of the outer cask.

4. The spent nuclear fuel storage container of claim 3 wherein the heat transfer medium is a heat pipe.

5. The spent nuclear fuel storage container of claim 2 wherein the heat engine is selected from a Rankine cycle engine, a Sterling cycle engine and a thermoelectric device.

6. The spent nuclear fuel storage container of claim 5 wherein the thermoelectric device is supported within the annular space on an outer surface of the canister.

7. The spent nuclear fuel storage container of claim 6 wherein the thermoelectric device is supported at an elevation substantially between the air inlet and the air outlet.

8. The spent nuclear fuel storage container of claim 7 wherein the thermoelectric device is supported substantially midway between the air inlet and the air outlet.

9. The spent nuclear fuel storage container of claim 1 wherein the heat engine has an electrical output that is connected to a coolant circulation system operable to cool a coolant.

10. The spent nuclear fuel storage container of claim 9 including an outer cask surrounding the canister with an annular space there-between and a coolant flow path between the canister and cask and through the cask to the exterior thereof, with the coolant circulation system circulating a fluid coolant between an interior of the annular space and an exterior of the cask.

11. The spent nuclear fuel storage container of claim 9 wherein the coolant circulation system cools the fluid within a spent fuel pool of a nuclear power plant.

12. The spent nuclear fuel storage container of claim 1 wherein the electric power forms an emergency auxiliary power source for a nuclear power plant.
